(19) United States
(12) Patent Application Publication
(10) Pub. No.: US 2003/0121867 A1
(43) Pub. Date: Jul. 3, 2003

(54) Method for separating each substance from mixed gas containing plural substance and apparatus thereof

(75) Inventors: Miwa Nakazawa, Kanagawa (JP); Kinya Kato, Kanagawa (JP); Teruyuki Endo, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKA KAISHA

(21) Appl. No.: 10/320,433

(22) Filed: Dec. 17, 2002

(30) Foreign Application Priority Data
Dec. 28, 2001 (JP) 400041/2001(PAT.)
May 9, 2002 (JP) 134099/2002 (PAT.
Dec. 10, 2002 (JP) 358066/2002 (PAT.

(51) Int. Cl. B03C 1/00

(52) U.S. Cl. 210/748

(57) ABSTRACT

The present invention provides a method for separating each substance from a mixed gas containing a plurality of substances comprising the steps of: liquefying the mixed gas by pressurizing; and separating the plural substances transferred into a liquid generated by the liquefying step into substances of one group and substances of the other group, wherein the substances of one group remains to substantially exist in the liquid, while the substances of the other group is separated from the liquid by evaporation.

### BACKGROUND OF THE INVENTION

1. Field of the Invention

The present invention relates to a method for separating each substance from a mixed gas containing a plurality of substances, and an apparatus used for the method.

2. Description of the Related Art

A vast quantity of organic chlorine compounds (for example chlorinated ethylene, chlorinated methane and the like) have been consumed with recent advance of industrial technologies, and disposal of these materials have became serious problems. Wastes from these substances have arose problems of environmental pollution, and much effort have been paid for solving the problems.

Photolysis methods by irradiation of UV light in a gas phase have been attempted as practical methods for disposal of decomposition objects retrieved from polluted soil and groundwater, in particular halogenated aliphatic hydrocarbon compounds. A method proposed includes irradiating waste gases containing organic halogen compounds with UV light to decompose into acidic decomposition gases, and rendering the decomposed gases harmless by washing with an alkali (Japanese Patent Laid-Open No. 62-191025). Also proposed is an apparatus for aerating waste water containing organic halogen compounds to the air, and washing the exhaust gases with an alkali after UV irradiation (Japanese Patent Laid-Open No. 62-191095).

In a different photolysis method, a decomposition apparatus of gaseous halogenated aliphatic hydrocarbon compounds is proposed, by which chlorine gas and gaseous halogenated aliphatic hydrocarbon compounds to be decomposed are mixed together, and the mixed gas is irradiated with UV light (EP 1010453A1). This decomposition apparatus takes advantage of chlorine gas generated from a solution containing chlorine as a simple and safe means for obtaining a gas containing chlorine gas.

Another method and apparatus for clarifying polluted soil have been proposed (Japanese Patent Laid-Open No. 2001-058177). The polluted soil is dispose in a predetermined clarification vessel, and functional water is fed into the clarification vessel. The polluted soil makes contact with functional water in the vessel, the mixture of the polluted soil and functional water is stirred, and pollutants in the soil start to dissolve into functional water. The pollutants dissolved in functional water are decomposed by decomposition ability of functional water when a light is irradiated to the mixture of polluted soil and functional water. The pollutants in the soil further dissolves into functional water as the concentration of the pollutants in functional water decreases, the dissolved pollutants are sequentially decomposed, and the pollutants are finally removed from the polluted oil with decomposition to achieve complete clarification of the polluted soil.

Functional water is referred to as a solution containing hypochlorous acid with low pH, and the solution available shows a hydrogen ion concentration (pH) of 1 to 4 and chlorine concentration of 5 to 150 mg/l. Such solution may be prepared, for example, by dissolving hypochlorous acid salts (such as sodium or potassium hypochlorite) and inorganic acids in water.

A solution formed in the vicinity of a positive electrode by electrolysis of water containing electrolytes is also called functional water, and is used for decomposition of the pollutants.

### SUMMARY OF THE INVENTION

Although various apparatus and methods for clarifying the polluted soil, and decomposition apparatus and methods of decomposition objects have been proposed, sufficient treatments of the decomposition products have not been applied in most of these proposals. Accordingly, the inventors of the present invention have noticed that it is preferable to apply additional separation or decomposition process to the decomposition products.

The present invention provides a method for separating each substance from mixed gases containing a plurality of substances, and an apparatus to be used for the method.

The present invention provides a method for separating each substance from a mixed gas containing a plurality of substances comprising the steps of: liquefying the mixed gas by cooling; and separating the plural substances transferred into a liquid generated by the liquefying step into the substances of one group and the substances of the other group, wherein the substances of one group substantially remain to present in the liquid and the substances of the other group are separated from the liquid by evaporation.

The present invention also provides an apparatus for separating each substance from a mixed gas containing a plurality of substances comprising: a pressurizing part for liquefying the nixed gas by pressurizing; and a device for separating the plural substances transferred into the liquid generated in the pressurizing part into the substances of one group and substances of the other group, wherein the substances of one group substantially remain to exist in the liquid by the separation device, while the substances of the other group are separated by evaporation from the liquid.

The present invention also provides a step for decomposing the separation objects present as a gas state after decomposition, and a step for liquefying the decomposition products formed in the decomposition step by pressurizing.

Chlorine may be separated from the liquid by adjusting the hydrogen ion concentration (pH value) of the liquid liquefied by pressurizing to 4 or less.

Further objects, features and advantages of the present invention will become apparent from the following description of the preferred embodiments (with reference to the attached drawings).

### BRIEF DESCRIPTION OF THE DRAWINGS

FIG. 1 illustrates a separation apparatus of substances according to one embodiment of the present invention.

FIG. 2 illustrates a separation apparatus of substances according to another embodiment of the present invention.

FIG. 3 illustrates a separation apparatus of substances according to a different embodiment of the present invention.

FIG. 4 illustrates a separation apparatus of substances according to a further different embodiment of the present invention.

FIG. 5 illustrates a separation apparatus of substances according to a further different embodiment of the present invention.

FIG. 6 illustrates a separation apparatus of substances according to a different embodiment of the present invention.

### DESCRIPTION OF THE PREFERRED EMBODIMENTS

Preferred embodiments of the present invention will be described hereinafter with reference to attached drawings.

The present invention provides a separation method of substances and an apparatus to be used for separation, wherein a mixed gas comprising a plurality of substances is liquefied by cooling. The plural substances transferred into a liquid generated by cooling are separated into the substances of one group and substances of the other group. The substances of one group substantially remain to exist in the liquid, while the substances of the other group is separated by evaporation from the liquid.

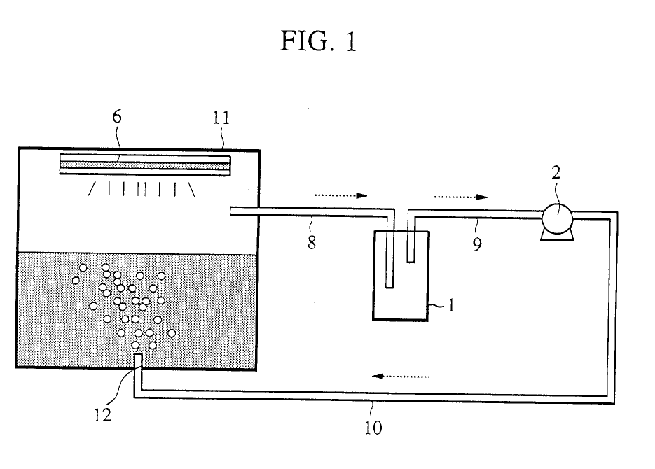

FIG. 1 shows the separation apparatus of substances according to the present invention.

The apparatus comprises a clarification tank 11 as a clarification vessel for pooling decomposition objects to be treated, a solution containing hypochlorous acid filled in the clarofocation tank 11, and a light irradiation device 6 for irradiating a light to a gas phase part in the clarification vessel 11.

In order to permit decomposition objects and substances necessary for decomposition to be efficiently transferred to a reaction field from a mixture comprising the decomposition objects and hypochlorous acid, the mixture is aerated through an aeration port 12. The decomposition objects are decomposed by irradiating a light to a gas obtained by aeration of the mixture containing the decomposition objects and hypochlorous acid. A circulation device 10 for circulating the aeration gas within a closed loop is provided for re-aeration of the treated gas after aeration. The reference numeral 2 denotes a pump for sending the gas.

The separation vessel is provided in the circulation device 10 as the closed loop, and the decomposition products are selectively separated and trapped therein. The gas containing the decomposition products after the decomposition treatment is sent to the separation vessel 1. The separation vessel 1 is provided with a piping 9 for introducing the treated gas and a piping 8 for discharging the treating gas into the vessel. Consequently, most of the decomposition products are pooled in the separation vessel 1 as a liquid by lowering the temperature below the temperature of decomposition treatment when the gas passes through the separation vessel 1.

When the substance as the decomposition object is chlorinated ethylene, the major decomposition products thereof are chloroacetic acids such as trichloroacetic acid, dichloroacetic acid and monochloroacetic acid. Chloroacetic acids are liquids at room temperature. When the decomposition object is a liquid, the decomposition products are commonly dissolved in a solution containing the decomposition objects. Since the decomposition reaction is performed in a gas phase in the present invention, the decomposition products exist as a mist (gaseous state) immediately after decomposition, or immediately after forming chloroacetic acid from chlorinated ethylene. It is possible to prevent the decomposition products from being pooled in the clarification tank 11 by purging the mist formed immediately after the reaction out of the clarification tank 11. The purged mist is liquefied by lowering the temperature below the decomposition treatment temperature when the mist passes through the separation vessel 1 disposed midway of the passageway of the pipes 8 and 9. The inventors of the present invention have found that a relatively slight decrease of the temperature is enough for liquefying the gaseous decomposition products. The liquid liquefied by cooling comprises a decomposition product containing a plurality of substances, for example chloroacetic acid and chlorine. The liquid gradually becomes acidic by continuously introducing chloroacetic acid as a decomposition product into the liquid comprising the decomposition product containing chloroacetic acid and chlorine. Chlorine in the liquid is discharged from the liquid as chlorine gas by the changes of the hydrogen ion concentration (pH value) of the liquid when it is acidified. The hydrogen ion concentration (pH value) of the liquid for discharging chlorine gas is preferably 4 or less, more preferably 1 to 4. The decomposition products are pooled in the separation vessel 1 as a concentrated liquid state, enabling the decomposition products to be separated from the clarified gas.

Discharge of chlorine gas may be accelerated by adding an acidic substance in the liquid.

The decomposition products may be liquefied by providing a cooling device in the separation vessel with a properly adjusted temperature of the cooling device.

It is desirable to decompose the pooled decomposition products using electrodes for electrolysis, thereby enabling a treated liquid substantially free from the decomposition products.

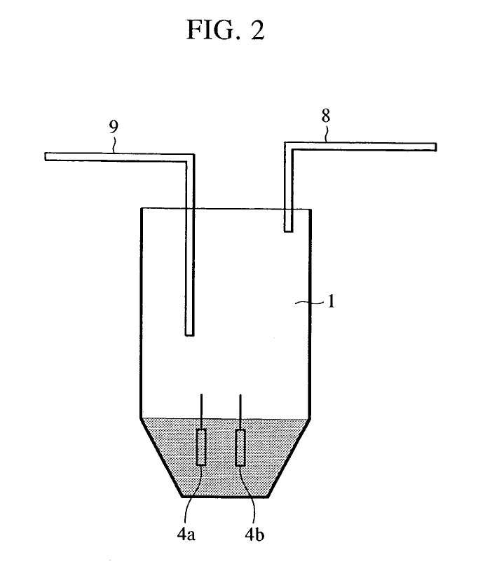

FIG. 2 shows an example of the separation vessel 1 using electrodes for electrolysis. Providing positive and negative electrodes for electrolysis in the separation vessel permits the remove decomposition products to be decomposed. The electrolysis electrodes 4a and 4b are placed at the bottom of the separation vessel 1 in FIG. 2, and the gas to be treated is introduced from the piping 9 and is discharged from the piping 8. The decomposition products are pooled in the separation vessel 1, and is converted into inorganic substances by electrolysis by the electrodes 4a and 4b.

Electrode materials known in the art such as gold, silver, platinum, nickel, iron, copper and lead, an alloy thereof, and stainless steel may be used for the electrodes for electrolysis. An electrolyte may be added to the solution comprising the decomposition products for electrolysis.

While the voltage applied between the electrodes and the amount of the electric current are not particularly restricted, it is recommended to perform decomposition at high concentrations since the amount of decomposition is proportional to the amount of electric power and the concentration of the decomposition objects.

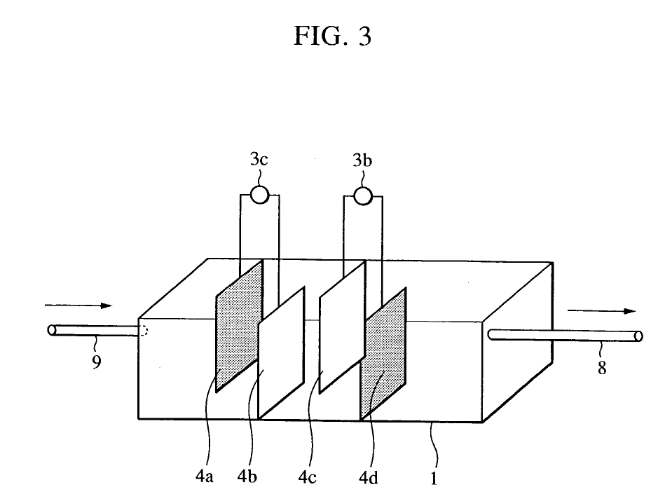

FIG. 3 shows a construction comprising plural pairs of the electrolysis electrodes.

The aqueous solution of hypochlorous acid to be used for decomposition includes an aqueous solution of a hypochlorous acid salt such as an aqueous sodium hypochlorite or potassium hypochlorite. It is also preferable to adjust the hydrogen ion concentration (pH value) to 1 to 4 by an adding inorganic or organic acid to the aqueous hypochlorous acid solution.

A solution (functional water) generated at near the positive electrode by electrolysis of water containing an electrolyte may be sued as the solution containing hypochlorous acid. The electrolyte is preferably a chloride.

A light irradiation device available for photolysis in the present invention is able to emit a light with a wavelength that can permeate through a glass, for example a light with a wavelength of 300 to 500 nm or a light with a wavelength of 350 to 450 nm. The solution liquefied in the separation vessel is preferably acidified. Acidifying permits generated chlorine to be separated from a solution containing the decomposition products and hypochlorous acid. Chlorine is recycled by sending to the clarification tank through the closed loop.

The hydrogen ion concentration of the acidic solution is preferably 4 or less, more preferably in the range of 1 to 4, in order to discharge chlorine as a gas.

The present invention is applicable, for example, to disposal of polluted water such as polluted groundwater, and treatment of high concentration solvents desorbed from activated charcoal.

While the decomposition objects available in the present invention is not particularly restricted, examples of them include chlorinated methylene and chlorinated methane. Examples of chlorinated ethylene include 1 to 4 chlorine substituents of ethylene such as monochloroethylene, dichloroethylene (DCE), trichloroethylene (TCE) and tetrachloroethylene (PCE). Examples of dichloroethylene include 1,1-dichloroethylene (vinylidene chloride) and cis-1,2-dichloroethylene, trans-1,2-dichloroethylene. Examples of chlorinated methane include chlorine substituents of methane such as monochloromethane, dichloromethane and trichloromethane.

The decomposition objects and chlorine gas may be independently fed to the photolysis reaction tank, instead of the feed method as described above. Chlorine gas fed from a chlorine cylinder may be used, or chlorine may be generated from a solution containing hypochlorous acid. Chlorine may be generated from the solution containing hypochlorous acid by aeration by introducing a gas, or chlorine generated at near the positive electrode by electrolysis may be used.

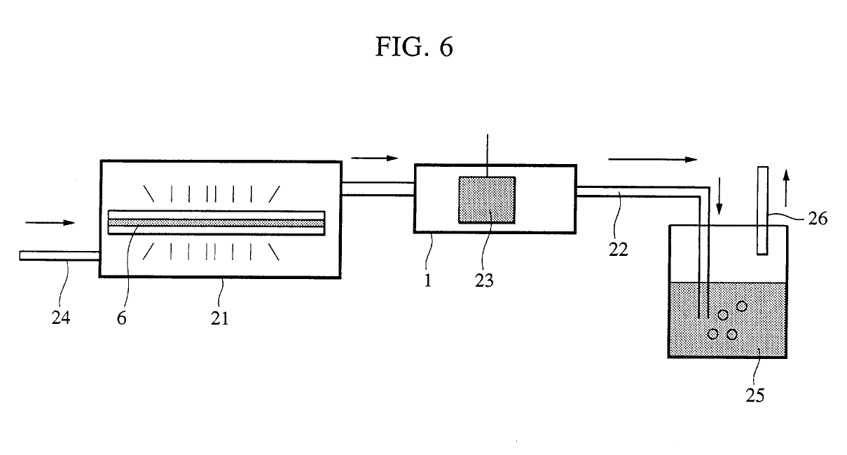

FIG. 6 shows a substance separation device according to an embodiment of the present invention. In this embodiment, a separation tank 25 is provided in order to separate the gas discharged from the separation vessel 1 from the substances to be separated in the gas. The gas containing the substance to be separated is transferred into the liquid by introducing the gas into the separation tank 25. For example, the liquid is an alkaline solution when the substance to be separated is chlorine.

### EXAMPLES

Examples of the present invention will be described hereinafter.

### Example 1

FIG. 1 shows an example of a polluted water clarifying system. In this system, a mixture of a solution containing polluted water and hypochlorous acid are aerated, and the aerated gas is irradiated with a light while circulating in a closed loop. A separation vessel for separation and decomposition of the decomposition products is disposed in the closed loop, and decomposition products are further separated and decomposed therein.

In this polluted water clarification system, polluted water is pooled in a predetermined position of the clarification tank 11, and a solution containing hypochlorous acid and an acid are added. The gas in the closed loop of the circulation passageway starts to circulate for aeration of the hypochlorous acid solution containing polluted water. Chlorine in the decomposition objects and hypochlorous acid solution is diffused in the gaseous phase and discharged, and the decomposition objects dissolved in polluted water is sequentially decomposed and separated by irradiating a light from a lamp as a light irradiation device 6.

The separation vessel 1 is placed in the closed loop of the aeration gas circulating passageway 10, the gas after treatment is sent into the separation vessel 1 through the piping 9, and the gas is circulated in the closed loop of the aeration gas circulating passageway 10 through the piping 8, thereby trapping the decomposition products in the separation vessel 1.

Decomposition of the retrieved solvent was experimentally confirmed using the apparatus shown in FIG. 1.

Desorbed water from activated charcoal was used as the decomposition object. Decomposition objects of the polluted gas extracted by a vacuum extraction method from the polluted soil comprising organic chlorine compound are absorbed on the activated charcoal. Desorbed water desorbed by steam distillation contained 350 mg/L of trichloroethylene and 320 mg/L of tetrachloroethylene.

Twenty liter of desorbed water was introduced into the clarification tank with a net volume of 50 L, followed by adding 12 mL of 12% sodium hypochlorite solution (containing about 12% of sodium hypochlorite immediately after production; made by Kishisa Chemical Co.; minimum amount of effective chlorine 5%) and 6 mL of hydrochloric acid (35% hydrochloric acid). As a result, desorbed polluted water showed a pH value of 2.5 and residual chlorine concentration of 70 to 90 mg/L.

Polluted water was further aerated by operating the pump 2 (APN215 made by Iwaki Co.). Air in the circulation passageway 10 was blown into the clarification tank 11 through an aeration port 12, and returns to the pump through the piping 9 for circulation. The flow speed was 25 L/min. The gas is prevented from being liquefied in the pump by providing the pump 2 at the downstream of the separation vessel 1, while the pump is hardly contaminated since the gas passing through the pump has been already treated.

A light was irradiated to treating water and gas phase through glass faces at both sides of the clarification tank 11. Ten units each of black light fluorescence lamps (made by Toshiba Co., trade name FL10BLB, 10W) were disposed at both sides for light irradiation.

After 1 hour's operation, the amounts of trichloroethylene and tetrachloroethylene in treated water were measured by EDC gas chromatography. The concentration of the pollutant in the gas phase was also measured.

The results showed that trichloroethylene and tetrachloroethylene were decomposed to a concentration of 0.03 mg/L or less.

After five cycles of operation for decomposition and clarification of desorbed water, the concentrations of the decomposition products in the separation vessel were measured, finding that 80% or more of the decomposition products as determined by calculation were separated in the separation vessel 1.

### Example 2

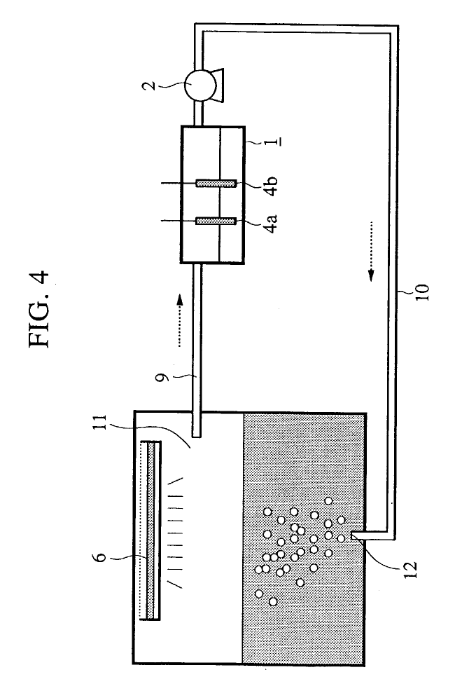

An experiment was performed using the substance separation apparatus shown in FIG. 4.

The experimental conditions are similar to those in Example 1, except that a separation vessel 1 having decomposition electrodes was disposed in the circulation passageway 10 as shown in FIG. 4 of this example in place of the separation vessel 1 shown in FIG. 1 in Example 1.

Most of the pulled decomposition products are converted into inorganic substances by flowing an electric current through the decomposition electrodes 4a and 4b in the separation vessel 1.

The decomposition products in the separation vessel 1 decomposed at a voltage of 14V with a current of 1 A using platinum electrode plates. The separation vessel 1 has a net volume of 500 ml, and is previously filled with 100 ml of 0.1% aqueous sodium chloride solution.

After the operation for 1 hour under the similar conditions as in example 1 except the conditions above, the amounts of trichloroethylene, dichloromethane, tetrachloroethylene, 1,1,1-trichloroethane and cis-1,2 -dichloroethylene, and the amount of the decomposition products mainly comprising chloroacetic acid were measured by HPLC and EDC gas chromatography. The concentrations of the decomposition objects and decomposition products of the decomposition objects in the gas phase were also measured.

The results showed that trichloroethylene and tetrachloroethylene were decomposed to the concentrations of 0.03 mg/L or less.

After 15 cycles' operation for clarification of desorbed water, the concentrations of the decomposition products in the separation vessel were measured. The decomposition products were further decomposed by electrolysis by flowing an electric current through the decomposition electrodes 4a and 4b in the separation vessel 1, finding that 95% or more of the decomposition-products trapped per unit time in the separation vessel 1 were decomposed into inorganic substances.

While electrolysis may be performed any time during the photolysis reaction, it is more effective to preform electrolysis when the concentrations of the decomposition products are increased to a certain extent. This is because a larger amount of the decomposition products are obtained with a smaller amount of electrical power as the concentrations of the decomposition objects are higher. Therefore, it is important to enhance the concentration in this context, and it is recommended to perform electrolysis as a higher concentration.

### Example 3

While the light source with a light wavelength of 300 nm to 500 nm was used as a light irradiation device in Example 2, a light source having a wavelength peak at 254 nm (for example a sterilization lamp) was used in this example. A light irradiation unit comprising the sterilization lamp inserted into a quartz tube was used in place of the black light, and the unit was placed in the clarification tank 11. The other experimental conditions were similar to those in Example 2. Trichloroacetic acid as the decomposition product was separated in the separation vessel, and it was also confirmed that trichloroacetic acid was decomposed by electrolysis at the electrodes in the separation vessel.

### Example 4

A decomposition object containing 150 mg/L of trichloroethylene, 100 mg/L of dichloromethane, 20 mg/L of 1,1,1-trchloroethane and 50 mg/L of cis-1,2-dichloroethylene was prepared as a retrieval solvent using the substance separation apparatus shown in FIG. 4. The experimental conditions were similar to those in Example 2 except the conditions above.

The results showed that the decomposition object was decomposed in the separation clarification tank, and the decomposition products were trapped in the separation vessel 1 and were decomposed to inorganic substances.

The decomposition products were separated by applying the decomposition method of the decomposition objects as described above, and it was possible to decompose most of the separated substances to inorganic substances by a simple method, if necessary.

### Example 5

A solution with a hydrogen ion concentration (pH value) of 3 was filled in the separation vessel 1 using the substance separation apparatus shown in FIG. 1. Other experimental conditions were similar to those in Example 1.

The results showed that the decomposition products were separated from chlorine in the separation vessel, and recycling of chlorine was possible.

### Example 6

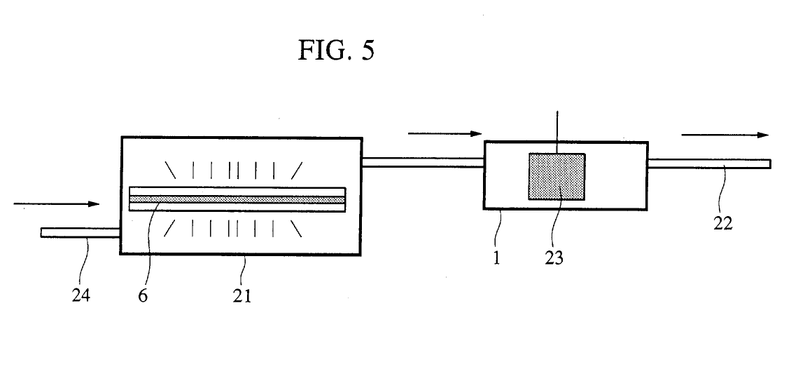

FIG. 5 shows a substance separation apparatus in this example. A mixture of the decomposition objects and chlorine in a photolysis reaction tank 21 are irradiated with a light from a light irradiation device 6 to decompose the decomposition objects. The gas containing the decomposition products after the decomposition treatment is continuously sent into the separation vessel 1 with a pump. The gas containing the decomposition products are readily liquefied by cooling the inside of the separation vessel 1 with a cooling device, and the liquefied gas is pooled in the separation vessel 1. The decomposition products and a treated gas containing no chlorine are discharged from an exhaust tune. Chlorine and chloroacetic acid of the gas containing the decomposition products may be fractionated, for example, by changing the setting temperature of the cooling device 23. Fractionated chlorine maybe introduced into the photolysis reaction tank again for recycling of chlorine.

A mixed gas comprising 100 ppmv of trichloroethylene and 50 ppmv of chlorine was sent into a photolysis reaction tank made of a glass through a feed pipe 24, and the mixed gas was irradiated with a light using a black light fluorescence lamp (trade name FL10BLB made by Toshiba Co., a 10 W light source with a peak at near the wavelength of 360 nm).

The photolysis reaction vessel had a bet volume of about 50 liter, and the mixed gas was sent into the tank so that the residence time becomes one minute.

For confirming that trichloroethylene is decomposed in the photolysis reaction tank 21, the concentration of trichloroethylene at the outlet of the piping 22 was measure to be 0.05 ppmV or less.

The major photolysis product of trichloroethylene is dichloroacetic acid. For confirming the effect of separating dichloroacetic acid by the cooling device, the system was operated by using the cooling device, and by controlling the temperature of the reaction vessel to be approximately equal to the temperature of the separation vessel 1 without using the cooling device. The concentration of dichloroacetic acid at the outlet of the piping 22 without decreasing the temperature, and the concentration of dichloroacetic acid at the outlet of the piping 22 by decreasing the temperature in the separation vessel 1 using the cooling device 23, were determined. The result showed that 90% or more of dichloroacetic acid was separated at the separation vessel 1 by cooling the vessel.

The cooling temperature changes depending on the concentration and air blow rate (residence time) of dichloroacetic acid in the example above. However, dichloroacetic acid as the decomposition product exists as a gas or mist in the example above, since trichloroethylene is decomposed in a gas phase. Since the boiling point of dichloroacetic acid is 192° C., it is readily liquefied at a relatively high temperature. Therefore, the cooling temperature may be about 20° C. to 50° C. Any cooling medium such as water or coolants may be used.

For separation of chlorine, a temperature below the boiling point of chlorine should be maintained using, for example, dry ice.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A method for separating each substance from a mixed gas containing a plurality of substances comprising the steps of:
liquefying the mixed gas by pressurizing; and
separating the plural substances transferred into a liquid generated by the liquefying step into substances of one group and substances of the other group,
wherein the substances of one group remains to substantially exist in the liquid, while the substances of the other group is separated from the liquid by evaporation.

2. A method according to claim 1,
wherein the substances of the other group is are evaporated by the changes of the properties of the liquid.

3. A method according to claim 1,
wherein the step for liquefying by pressurization is to pressurize the mixed gas by a resistance given by a resistance member to a stream of the mixed gas.

4. A method according to claim 1,
wherein the step for liquefying by pressurization is to pressurize the mixed gas with a pump.

5. A method according to claim 1,
wherein the mixed gas comprises at least an acidic substance and chlorine.

6. A method according to claim 5,
wherein the liquid generated by the liquefying step is an acidic solution.

7. A method according to claim 6,
wherein the hydrogen ion concentration (pH value) of the acidic solution is 4 or less.

8. A method according to claim 6,
wherein the acidic substance remains to exist in the acidic solution, and the acidic substance is separated from chlorine by evaporating chlorine from the liquid.

9. A method according to claim 8, further comprising the step of allowing evaporated chlorine to contact an alkaline solution.

10. A method according to claim 1,
wherein the mixed gas is a gas comprising decomposition products generated by decomposition of a decomposition objects by irradiating a light.

11. A method according to claim 10,
wherein the decomposition objects are organic chlorine compounds.

12. A method according to claim 11,
wherein the light is irradiated in the presence of chlorine.

13. A method according to claim 1, further comprising the step of subjecting the liquid generated by the liquefying step to electrolysis.

14. A method according to claim 10,
wherein the gas containing the substances of the other group is used for decomposition again.

15. An apparatus for separating each substance from a mixed gas containing a plurality of substances comprising:
a pressurizing part for liquefying the mixed gas by pressurization; and
means for separating the plural substances transferred into a liquid generated in the pressurizing part into the substances of one group and substances of the other group,
wherein the substances of one group substantially remains to exist in the liquid by the separation means, and the substances of the other group are separated from the liquid by evaporation.

16. An apparatus according to claim 15,
wherein the pressurizing part comprises a resistance member for giving a resistance to a stream of the mixed gas.

17. An apparatus according to claim 15,
wherein the pressurizing part comprises a pump.

18. An apparatus according to claim 15, further comprising means for electrolysis of the liquid generated in the liquefying step.
